(19) United States
(12) Patent Application Publication
(10) Pub. No.: US 2021/0269310 A1
(43) Pub. Date: Sep. 2, 2021

(54) PROCESS FOR REMOVING CADMIUM AND OTHER METALS AND IMPURITIES IN PHOSPHATE-CONTANING MATERIALS

(71) Applicants: Mai ATTIA, Saint-Constant (CA); Sherif FARAG, Saint-Constant (CA); Jamal CHAOUKI, Dorval (CA)

(72) Inventors: Mai ATTIA, Saint-Constant (CA); Sherif FARAG, Saint-Constant (CA); Jamal CHAOUKI, Dorval (CA)

(21) Appl. No.: 17/250,294

(22) PCT Filed: Jun. 28, 2019
(86) PCT No.: PCT/CA2019/050904

§ 371 Date: Dec. 29, 2020

Related U.S. Application Data
(60) Provisional application No. 62/692,669, filed on Jun. 30, 2018.

(51) Int. Cl. C01B 25/32; C01B 25/238; C01B 25/12; B01D 21/01; C22B 3/00

(52) U.S. Cl. CPC C01B 25/327; C01B 25/238; C01P 2006/80; B01D 21/01; C22B 17/04; C01B 25/12

(57) ABSTRACT

A process for removing metals and other impurities in a phosphate-containing material, comprising causing the material to react with a metal removing agent which comprises an organophosphorus compound. The process may be integrated to existing transportation and/or storage facilities for phosphate-containing materials.

### CROSS REFERENCE TO RELATED APPLICATIONS

This application claims benefit of U.S. Provisional Patent Application No. 62/692,669, filed on Jun. 30, 2018, the content of which is incorporated herein in its entirety by reference.

### FIELD OF THE INVENTION

The present invention relates generally to processes for removing metals and impurities in a phosphorus-containing material. More specifically, the invention relates to a process for removing Cd and other metals and impurities in a phosphate-containing material. The process according to the invention uses a metal removing agent which comprises an organophosphorus compound. The process according to the invention may be integrated to existing transportation and/or storage facilities for phosphate-containing materials.

### BACKGROUND OF THE INVENTION

Phosphate-containing materials are used in various applications. For example, phosphate rocks are used in the production of phosphate fertilizers for agriculture. Phosphorus in phosphate rocks may be in the form of phosphate (PO₄³⁻) or phosphoric acid (H₃PO₄) or in the form of phosphate pentoxide (P₂O₅). Its content varies from 4 to 20 wt % depending on the origin of the phosphate rocks.

Phosphate rocks also comprise metals and other impurities. Some metals present in phosphate rocks are harmful for the environment and are toxic for biological systems. Indeed, they are known to produce superoxide and hydroxyl radicals which can damage cellular tissue and cause various adverse effects, ultimately leading to the death of the biological system. Such metals include Cd, Cu, Cr, Ni, Pb, Fe, V and Zn. Cd is considered one of the most toxic metal in phosphate rocks. Removal of these metals before processing the phosphate rocks to yield fertilizers is highly desirable.

Although Cd concentrations in food, such as vegetables, potatoes and grains, are in trace amounts, they can build up significantly in the human body and thus have a severe impact on human health. Several health protection agencies, such as the U.S. National Toxicology Program and European Commissions, have placed some limitations on the level of Cd in soil used to grow plants as food for human and animal consumption. This international standard forces countries to reduce Cd concentrations in water and soil to under 5 mg/kg, and imposes the use fertilizers with zero Cd content or below a set amount.

Consequently, during the last decades, there has been an increase in the amount of research work aimed at removing Cd from phosphate-containing materials. Generally, as will be seen in the description of the documents outlined below, the processes known in the art are conducted under conditions that may be qualified as harsh and/or involve relatively high costs.

U.S. Pat. No. 7,998,441 discloses a method for removing cadmium and other heavy metals such as nickel and cobalt from an aqueous solution with a thiourea based resin (Lewatit TP 214 resin), which should be activated with a hydrochloric acid solution. Later, the cadmium-loaded resin is eluted with water and regenerated in order to be used again. The resin used is costly and requires an amount of hydrochloric acid four times of its volume to be activated and ready for cadmium adsorption.

U.S. Pat. No. 5,246,681 discloses a process for removing cadmium from phosphoric acid solutions via at least two ion-exchange resin fixed-beds (containing high percentage of styrene-divinylbenzene) at a temperature between 15 to 50° C. This process requires a bromide ions in the form of hydrogen bromide or alkaline metal bromides (such ion-exchange resin beds as KBr) and 1 to 5 wt % of a condensed polyphosphatic chemical such as sodium hexamethaphosphate. An ion-exchange resin beds are essential to absorb cadmium from the phosphoric acid solution that is expensive to build and operate. The resin matrixes with styrene-divinylbenzene are expensive and need to be regenerated regularly in order to have a full capacity to absorb cadmium ions. Moreover, the temperature should be increased up to 50° C. to have better performance.

U.S. Pat. No. 4,986,970 discloses a method for removing heavy metals, especially cadmium, from phosphoric acid containing solutions. In the technique described, phosphoric acid stream is pre-purified, and all insoluble particles should be removed. Then, the solution is partially neutralized with ammonia to pH 1.4 to 2, and simultaneously cooled down to a temperature in the range of 5 to 40° C. By the addition of metal salts of dithio carbonic acid-O-esters, thereafter, the heavy metal ions are removed in the form of precipitates via flotation and filtration processes. The costs involved are high due to the two-step filtration process, before and after the treatment, the ester metal salt used in the extraction, and the cooling down of the stream followed by the partial neutralization of it with ammonia.

U.S. Pat. No. 4,634,580 discloses a process for removing heavy metal ions such as cadmium and uranium from industrial phosphoric acid solution by a cadmium-collector anionic surface-active agent followed by a flotation process. The contained iron in phosphoric acid should firstly be reduced from trivalent state to divalent state. Then, a cadmium-collector surface active reagent, which is selected from the group of dithiophosphoric acid esters and the alkali metal salts (for example sodium diethyl dithiophosphate), is introduced to the phosphoric acid stream at the temperature between 20 and 100° C. Finally, with the help of an injected gas bubbles in the solution, the heavy metal ions that are attached to the bubbles and removed by flotation.

U.S. Pat. No. 4,975,162 discloses an electrodepositing method for removing cadmium from various kind of solutions (aqueous and acidic solutions). In this patent, conducting particulates present in the packed or fluidized bed cathode in an electrolysis cell are applied to reduce cadmium ions and deposit them on the cathode surface. The cathode can be metal particles such as copper or graphite. This electrolysis cell requires the current density of 100 to 500 A/m² with a voltage of 2.2 to 12 V. Later, cathode particulates are regenerated by treatment with sulfuric acid. The process requires a considerable amount of electricity and not suitable for phosphate rocks solution or slurries because it needs electrolyte solution in order to migrate cadmium ions easily and precipitate them on the cathode.

U.S. Pat. No. 4,425,236 discloses a process for removing cadmium from aqueous media by contacting the solution with an effective amount of a water-insoluble organic polysulfide chemical that can selectively absorb cadmium ions. The polysulfide compound, such as liquid polysulfide polymer or oligomer, can form salts with cadmium and extract it from the aqueous solutions. The process cost involves is high, and the extracting agent used is unstable during the metal extraction. Also, a considerable amount of the agent, around 100 g, is required to remove 100 mg of cadmium.

U.S. Pat. No. 4,405,570 discloses a process for selectively removing copper or cadmium ions from a sulfate solution. The process is performed at high temperature, about 85 to 95° C. and the pH of the solution is in the range of 4.5 to 5.5. In this environment, the heavy metal ions can react with hydrogen sulfide gas and produce insoluble metal sulfides which can be easily removed by precipitation method. The process requires elevated temperature and the addition of a hazard gas such as hydrogen sulfied for the extraction. This technique requires a pH higher than 4, which is not suitable for application in a phosphoric acid solution. Indeed, such condition would lead to an increase of the formation of sulfide ions in the solution which hinders the cadmium removal process.

EP 0244021 discloses a process which uses anionic exchanger resins to remove cadmium from aqueous phosphoric acid solutions. It is stated that by applying an anion exchanger in the presence of a small quantity of iodide and bromide ions, 90% of cadmium could be removed with a temperature range between ambient and 130° C. The anionic exchangers can exist in different forms such as strong basic anion exchanger, e.g. of the type PS—CH₂N(CH₃)³⁺, or a weakly basic anion exchanger, e.g. of the type PS—CH₂N(CH₃)₂, or a weak basic anion exchanger, e.g., the type PS—C₆H₄NH₂—in which PS in each case represents a cross-linked polystyrene. This method requires a packed or fluidized beds in order to provide their highest adsorption capacity. Furthermore, applying high temperature and a regeneration process for the resins consume a high energy.

WO 2004/083118 discloses a single step process for removing heavy metal ions such as cadmium, copper, lead, nickel, arsenic and mercury ions from wet-process phosphoric acid. Such process can be applied on the crude acid prior to gypsum filtration or the filtered phosphoric acid. It uses a chemical composition of a diorgano dithiophosphinic acid (or alkali metal or ammonia salts thereof), a first dithiophosphoric acid (or alkali metal or ammonia salts thereof) with alkyl or alkylaryl or aralkyl moieties and a second diaryl dithiophosphoric acid (or alkali metal or ammonia salts thereof). The removal efficiency of the process reaches up to 80% of heavy metal ions from phosphoric acid stream. Although the process appears simple, the chemical materials used are expensive, which makes the process not economical for scale up.

U.S. Pat. No. 5,405,588 discloses a process for removing cadmium from phosphoric acid solution via multi-step processes. By adding ammonium carbonate and an oxidizing reagent to the aqueous solution, cadmium reacts with the ammonium carbonate to form a water-soluble amine complex. Then, by evaporating the first mixture, the amine complex dissociates and forms cadmium carbonate. After this step, by adding hydrogen sulfide solution or ammonium sulfide, cadmium was extracted in the form of cadmium sulfide. Many steps are involved in the process, requiring more equipment to properly perform and control each step. Besides, it needs to evaporate some part of acid solution, that makes it expensive and energy consuming.

The Applicants are also aware of the following documents: U.S. Pat. Nos. 4,492,680; 5,068,094; EP 0482160; KR 900000080; DE 3,327,394; U.S. Pat. Nos. 4,511,543; 4,017,585; EP 0154554; U.S. Pat. No. 4,592,900; and CN 106495110.

There is still a need for processes aiming at removing Cd and other metals and impurities from phosphate-containing materials. There is a need for such processes which are cost-effective and conducted under mild conditions.

### SUMMARY OF THE INVENTION

The inventors have designed and conducted a process for removing Cd and other metals and impurities from a phosphorus-containing material. The process according to the invention uses a metal removing agent which comprises an organophosphorus compound. The process is conducted under mild conditions, and the metal removing agent and any water used may be recovered, regenerated and re-used in the process. Also, the process may be integrated to an existing facility for the transportation and/or storage of the phosphorus-containing material, thereby avoiding the building of an additional or separate treatment facility.

In embodiments of the invention, the phosphorus-containing material contains at least one of phosphate, phosphoric acid and phosphate pentoxide.

In embodiments of the invention, the metal removing agent is suitable for removing cadmium (cadmium removing agent); but is also suitable for removing other metals and impurities present in the starting phosphorus-containing material.

The invention thus provides the following in accordance with aspects thereof:

(1) A process for removing metals and other impurities in a phosphorus-containing material, comprising causing the material to react with a metal removing agent which comprises an organophosphorus compound.
(2) The process according to (1) above, wherein the phosphorus in the phosphorus-containing material is in a form which is: phosphate (PO₄³⁻), phosphoric acid (H₃PO₄), phosphate pentoxide (P₂O₅) or a derivative thereof or a combination thereof.
(3) The process according to (1) above, wherein the material is a phosphate-containing material.
(4) The process according to claim any one of (1) to (3) above, wherein the material is phosphate rocks or a sediment or a combination thereof.
(5) The process according to claim any one of (1) to (4) above, wherein the metals and other impurities, as measured by Neuron Activation Analysis, comprise at least one of: Cd, U, Ca, V, Ti, Sn, Sr, Ag, Mn, Si, Al, Mg, Na, Fe, K, Zn, Cr, Cl, V, Co, Ni, Cu, As, Se, Br, Rb, Zr, Mo, In, Sn, Sb, I, Cs, Ba, La, Hf, W, Hg, Th and Sc.
(6) The process according to claim any one of (1) to (4) above, wherein the metals and other impurities comprise cadmium (Cd).
(7) The process according to any one of (1) to (6) above, wherein the metal removing agent comprises a phosphate ester of general formula I outlined below

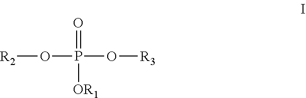

wherein R₁ to R₃ are each independently a C₁ to C₂₀ a linear or branched, cyclic or non-cyclic, saturated or unsaturated alkyl group, optionally comprising a heteroatom which is O, S or N.
   (8) The process according to any one of (1) to (6) above, wherein the metal removing agent comprises a phosphoric acid ester of general formula II outlined below

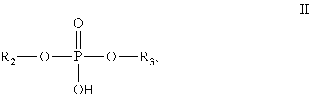

wherein R₂ and R₃ are each independently C₁ to C₂₀ a linear or branched, cyclic or non-cyclic, saturated or unsaturated alkyl group, optionally comprising a heteroatom which is O, S or N.
   (9) The process according to (7) or (8) above, wherein R₁ to R₃ are each independently a C₂ to C₁₀ or a C₂ to C₈ a linear or branched, cyclic or non-cyclic, saturated or unsaturated alkyl group, optionally comprising a heteroatom which is O, S or N.
   (10) The process according to any one of (1) to (6), wherein the metal removing agent comprises di-(2-ethylhexyl)phosphoric acid (DEHPA or HDEHP) outlined below

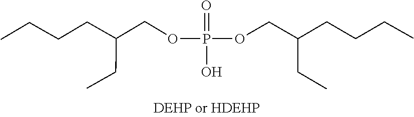 [SMILES: CCCCC(CC)COP(=O)(O)OCC(CC)CCCC]

(11) The process according to any one of (1) to (6) above, wherein the metal removing agent is selected from the group consisting of: di-(2-ethylhexyl) phosphoric acid, bis(2-ethylhexyl) phosphate, bis(2-ethylhexyl) hydrophosphoric acid, bis(2-ethylhexyl) hydrogen phosphate, bis(2-ethylhexyl) orthophosphate, di-(2-ethylhexyl) orthophosphoric acid, dioctyl hydrogen phosphate, dioctyl orthophosphate, dioctyl phosphate, 2-ethyl-1-hexanol hydrogen phosphate, 1-hexanol-2-ethyl hydrogen phosphate, hydrogen bis(2-ethylhexyl) phosphate, O,O-bis(2-ethylhexyl)phosphoric acid, orthophosphoric acid 2-ethylhexyl alcohol, phosphoric acid di(2-ethylhexyl) ester and Hostarex PA 216™.
(12) The process according to any one of (1) to (11) above, wherein the metal removing agent is a cadmium removing agent.
(13) The process according to any one of (1) to (12) above, wherein the temperature is: about 15 to 50° C., about 20 to 40° C., about 20 to 35° C., about 20 to 30° C., about 25° C., about 40 to 120° C., about 50 to 100° C., about 60 to 100° C., about 70 to 100° C., about 80 to 100° C., about 100° C.
(14) The process according to any one of (1) to (12) above, wherein the temperature is the ambient temperature.
(15) The process according to any one of (1) to (12) above, wherein the temperature is about 100° C.
(16) The process according to any one of (1) to (15) above, which is conducted at ambient pressure, or at a pressure of about 100 bars, or at a pressure higher than 100 bars.
(17) The process according to any one of (1) to (15) above, which is conducted at ambient pressure.
(18) The process according to any one of (1) to (17) above, further comprising at least one of: a decantation and filtration step, and a washing step, optionally the decantation and filtration step and/or the washing step is repeated one time or more.
(19) A process for removing metals and other impurities in a phosphorus-containing material, comprising: (i) providing the phosphorus-containing material; (ii) adding a metal removing agent which comprises an organophosphorus compound, and stirring the mixture for a period of time, to yield a mixture comprising a treated phosphorus-containing material and a reacted metal removing agent; (iii) adding a washing fluid comprising water and an organic solvent, and stirring the mixture for a period of time; and (iv) separating the treated phosphorus-containing material which is in solid form and the washing fluid comprising the reacted metal removing agent; optionally steps (iii) and (iv) are repeated one time or more, the washing fluid being the same or different.
(20) A process for removing metals and other impurities in a phosphorus-containing material, comprising: (a) providing the phosphorus-containing material; (b) preparing a slurry of the phosphorus-containing material in water and maintaining the slurry under stirring; (c) adding a metal removing agent which comprises an organophosphorus compound to the slurry under stirring, and stirring the mixture for a period of time; (d) stopping the stirring and allowing the mixture to stand for a period of time, thereby causing formation of a precipitate comprising a treated phosphorus-containing material and a layer of water comprising a reacted metal removing agent; (e) separating the precipitate comprising the treated phosphorus-containing material from the layer of water; (f) washing the precipitate comprising the treated phosphorus-containing material using a washing fluid comprising water and an organic solvent; and (g) separating the treated phosphorus-containing material from the washing fluid, optionally steps (f) and (g) are repeated one time or more, the washing fluid being the same or different.
(21) The process according to (19) or (20) above, wherein step (ii) or step (c) is conducted at a temperature of about 15 to 50° C., about 20 to 40° C., about 20 to 35° C., about 20 to 30° C., about 25° C., about 40 to 120° C., about 50 to 100° C., about 60 to 100° C., about 70 to 100° C., about 80 to 100° C., about 100° C.
(22) The process according to (19) or (20) above, wherein step (ii) or step (c) is conducted at ambient temperature.
(23) The process according to (19) or (20) above, wherein step (ii) or step (c) is conducted at a temperature of about 100° C.
(24) The process according to (19) or (20) above, wherein step (ii) or step (c) is conducted at ambient pressure, or at a pressure of about 100 bars, or at a pressure higher than 100 bars.
(25) The process according to (19) or (20) above, wherein step (ii) or step (c) is conducted at ambient pressure.
(26) The process according to any one of (19) or (25) above, wherein step (ii) or step (c) is conducted in a phase which is liquid, gas, plasma or a combination thereof.
(27) The process according to (20) above, wherein step (f) comprises adding the washing fluid to the precipitate and stirring the mixture for a period of time.
(28) The process according to (20) above, further comprising submitting the layer of water of step (e) to a treatment to recover and regenerate the metal removing agent and water, separately; optionally each of the metal removing agent and water recovered is re-used in the process.
(29) The process according to any one of (19) to (28) above, further comprising submitting the washing fluid of step (iv) or step (g) to a treatment to recover and regenerate the metal removing agent and water, separately; optionally each of the metal removing agent and water recovered is re-used in the process.
(30) The process according to any one of (19) to (29) above, wherein an amount of the metal removing agent is about 0.1 to 100 vol % or about 10 to 100 vol % or about 20 to 100 vol % or about 30 to 100 vol % or about 40 to 100 vol % or about 50 to 100 vol % or about 60 to 100 vol % or 70 to 100 vol % or about 80 to 100 vol % or about 90 to 100 vol % or about 100 vol % based on an amount of the phosphorus-containing material.
(31) The process according to any one of (19) to (29) above, wherein an amount of the metal removing agent is about 0.1 to 15 vol % or about 0.1 to 10 vol % or about 0.1 to 5 vol % or about 0.1 to 3 vol % or about 0.1 vol % or about 1 vol % based on an amount of the phosphorus-containing material.
(32) The process according to any one of (19) to (31) above, wherein the organic solvent is an alcohol, optionally a C₁ to C₆ alcohol including ethanol.
(33) The process according to any one of (19) to (32) above, wherein an amount of the organic solvent in the washing fluid is about 0.1 to 15 vol % or about 0.5 to 10 vol % or about 1 to 8 vol % or about 1 to 5 vol % or about 1 vol %.
(34) The process according to (21) above, wherein a temperature higher than ambient temperature is provided using microwave, ultrasound, induction heating, plasma or a combination thereof.
(35) The process according to any one of (19) to (34) above, wherein stirring is provided using a mechanical stirrer or a gas flow comprising air, nitrogen or a combination thereof.
(36) The process according to any one of (1) to (35) above, which is conducted as a continuous flow, a batch, a semi-batch or a combination thereof.
(37) The process according to any one of (19) to (36) above, wherein the phosphorus-containing material is a phosphate-containing material.
(38) A phosphorus-containing material treated according to the process as defined in any one of (1) to (37) above.
(39) The phosphorus-containing material according to (38) above, which has a metal and other impurities content lower than a metal and other impurities content in the starting phosphorus-containing material.
(40) The phosphorus-containing material according to (38) above, which has a cadmium content lower than a cadmium content in the starting phosphorus-containing material.
(41) The phosphorus-containing material according to (38) above, which has a cadmium content about to 1 to 100% lower than a cadmium content in the starting phosphorus-containing material.
(42) The phosphorus-containing material according to (38) above, which has a cadmium content about 10 to 20% or about to 30 to 40% or about 40 to 50% or about 50 to 60% or about 60 to 70% or about 70 to 80% or about 80 to 90% or about 90 to 100% or about 32% or about 54% or about 88% lower than a cadmium content in the starting phosphorus-containing material.
(43) The phosphorus-containing material according to (38) above, which is substantially free of cadmium.
(44) A system adapted to conduct the process as defined in any one of (1) to (37) above.
(45) A transportation and/or storage system for the transportation and/or storage of a phosphorus-containing material, comprising a system adapted to conduct the process as defined in any one of (1) to (37) above; optionally the transportation and/or storage system is a pipeline, a tank, a container or a combination thereof.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Flowchart outlining the process according to the invention.

FIG. 2: Phosphate rocks in raw/untreated state (A) and after treatment according to the process of the invention (B).

FIG. 3: Metal removing agent before use (A) and after use in the process of the invention (B).

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein when referring to numerical values or percentages, the term “about” includes variations due to the methods used to determine the values or percentages, statistical variance and human error. Moreover, each numerical parameter in this application should at least be construed in light of the number of reported significant digits and by applying ordinary rounding techniques.

As used herein, the term “phosphorus-containing material” refers to a material comprising the element phosphorus. Phosphorus may be present in the material in various forms. Such forms may be for example phosphate (PO₄³⁻), phosphoric acid (H₃PO₄), phosphate pentoxide (P₂O₅) or a derivative thereof or a combination thereof.

As used herein, the term “phosphate-containing material” refers to a phosphorus-containing material wherein phosphorus is present in the form phosphate (PO₄³⁻) or a derivative thereof. It should be mentioned that a phosphate-containing material as used herein may also comprise phosphorus in other forms such as phosphoric acid (H₃PO₄), phosphate pentoxide (P₂O₅) or a derivative thereof or a combination thereof. Accordingly, it can be seen that the terms “phosphate-containing material” and “phosphorus-containing material” are sometimes used interchangeably in the present disclosure.

As used herein, the term “metal removing agent” refers to a chemical agent which comprises an organophosphorus compound and which is suitable for reacting with a metal and also with other impurities present in the raw phosphorus-containing material, to yield a reacted metal removing agent. It should be noted that the metal removing agent is suitably selected such that the reacted metal removing agent may be submitted to a suitable treatment to recover and regenerate the metal removing agent.

As used herein, the term “cadmium removing agent” or “decadmiation agent” refers to a chemical agent which comprises an organophosphorus compound and which is suitable for reacting with cadmium; but also with other metals and impurities present in the raw phosphorus-containing material, to yield a reacted cadmium removing agent or reacted decadmiation agent. It should be noted that the cadmium removing agent is suitably selected such that the reacted cadmium removing agent may be submitted to a suitable treatment to recover and regenerate the cadmium removing agent.

As used herein, the term “reacted metal removing agent” or “reacted cadmium removing agent” refers to a product obtained when the raw phosphorus-containing material is allowed to reaction with the metal removing agent or cadmium removing agent. It should be noted that the reacted metal removing agent or reacted cadmium removing agent is present in the water obtained when the treated phosphorus material is filtered off. The terms “reacted metal removing agent” and “reacted cadmium removing agent” are sometimes used interchangeably in the present disclosure.

As used herein, the term “washing fluid” refers to a mixture of water and an organic solvent used to wash the treated phosphorus-containing material after removal of the layer of water.

The inventors have designed and conducted a process for removing Cd and other metals and impurities from a phosphorus-containing material. The process uses a metal removing agent which comprises an organophosphorus compound. The metal removing agent and any water used may be recovered, regenerated and re-used in the process. Also, the process may be integrated to an existing facility for the transportation and/or storage of the phosphorus-containing material, thereby avoiding the building of an additional or separate treatment facility.

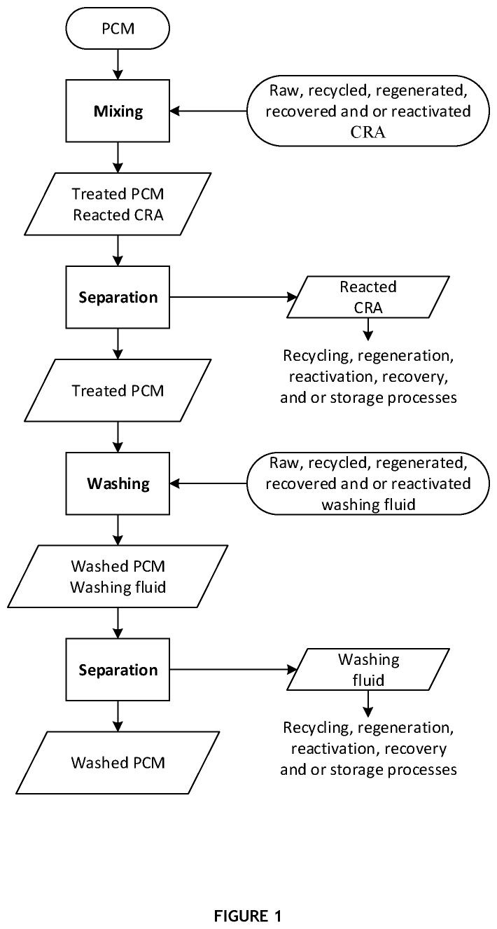

An embodiment of the invention is outlined in FIG. 1. Raw phosphate-containing (PCM) is mixed with a cadmium removing agent (CRA) in water to yield the treated PCM and reacted CRA. These two entities and then separated. The treated PCM is washed using a washing fluid, a first time, then a second time. Each time, washing is followed by separation step to separate the washing fluid from the washed treated PCM. As can be seen on the figure, water obtained after the various steps may be submitted to a suitable treatment to recover the treated CRA, which may further be regenerated/reactivated to yield the CRA. The regenerated/reactivated CRA may be re-use in the process.

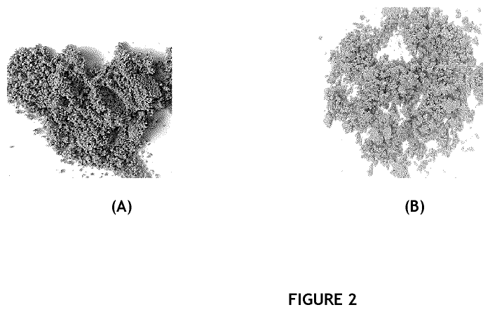

The phosphorus-containing material used in the process according to the invention may consist of phosphate rocks. This material is presented in FIG. 2. As can be seen, the material has a dark color when in raw state (FIG. 2A); and has a lighter color after treatment according to the process of the invention (FIG. 2B).

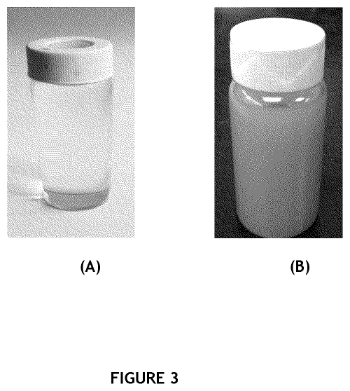

FIG. 3 presents the cadmium removing agent or decadmiation agent, di-(2-ethylhexyl)phosphoric acid. As can be seen, it is an almost translucid liquid before use (FIG. 3A), and an almost opaque liquid after use (FIG. 3B).

### Example 1

An experimental setup consisting of a batch reactor was used to conduct the process. A 500 g slurry comprising about 40 vol % of raw phosphate-containing material and about 60 vol % of water, was placed inside the reactor, and kept under stirring condition (about 300 rpm). A dosage of di-(2-ethylhexyl)phosphoric acid in an amount of about 1-5 vol % based on the amount of phosphate-containing material, was added into the slurry under stirring condition. The mixture was kept under stirring condition for about 24 hours, at ambient pressure and ambient temperature.

Then, the stirrer was turned off and the mixture was decanted. This resulted in the treated phosphate-containing material being precipitated from the aqueous phase which comprises the cadmium removing agent that has reacted with cadmium and other metals and impurities.

Decantation and filtration steps were conducted to separate the treated phosphate-containing material (precipitate) from the reacted cadmium removing agent (aqueous phase). The treated cadmium removing agent was subjected to a first washing process using a mixture of water and ethanol, ethanol being present in an amount of about 1 vol %. The amount of washing fluid used was about 50 wt % based on the amount of raw phosphate-containing material. The washing process was conducted by mixing the washing fluid with the treated phosphate-containing material; and keeping the mixture under stirring condition at ambient pressure and ambient temperature for about 30 minutes. Decantation and filtration processes were then conducted to separate the washed treated phosphate-containing material from the washing fluid. The washed treated phosphate-containing material was subjected to a second washing process similarly to the first washing process.

Ultimately, the washed treated phosphate-containing material was sent to Neutron Activation Analysis to identify the elements present in the material and determine the concentration of each of the elements. The results obtained are outlined in Table 1 below.

TABLE 1
Concentration of elements in the phosphate-containing material before
and after treatment (24 hours, ambient temperature, and ambient
pressure). Data obtained from Neutron Activation Analysis.

| | Raw phosphate- | Treated phosphate- | |
|---|---|---|---|
| | containing material | containing material | Removal |
| Element | (mg/kg) | (mg/kg) | efficiency |
| Cd | 28 | 19 | 32% |
| U | 133 | 111 | 17% |
| Ca | 289797 | 289168 | 0% |
| V | 136 | 67 | 51% |
| Tl | 180 | 92 | 49% |
| Sn | 4.7 | 0 | 100% |
| Sr | 555 | 553 | 0% |
| Ag | 60 | 30 | 50% |
| Mn | 11 | 8 | 27% |
| Si | 16956 | 2999 | 82% |
| Al | 4407 | 829 | 81% |
| Mg | 8976 | 6163 | 31% |

### Example 2

The experimental setup was the same as in Example 1. The mixture of raw phosphate-containing material in water and cadmium removing agent was kept under stirring condition for about 48 hours, at ambient pressure and ambient temperature. Decantation, filtration, and first and second washing processes as defined in Example 1 were also conducted. The washed treated phosphate-containing material was sent to Neutron Activation Analysis to identify the elements present in the material and determine the concentration of each of the elements. The results obtained are outlined in Table 2 below.

TABLE 2
Concentration of elements in the phosphate-containing material before
and after treatment (48 hours, ambient temperature, and ambient
pressure). Data obtained from Neutron Activation Analysis.

| | Raw phosphate- | Treated phosphate- | |
|---|---|---|---|
| | containing material | containing material | Removal |
| Element | (mg/kg) | (mg/kg) | efficiency |
| Cd | 28 | 13 | 54% |
| U | 133 | 77 | 42% |
| Ca | 289797 | 289500 | 0% |
| V | 136 | 51 | 63% |
| Tl | 180 | 85 | 53% |
| Sn | 4.7 | 0 | 100% |
| Sr | 555 | 485 | 13% |
| Ag | 60 | 24 | 60% |
| Mn | 11 | 5 | 55% |
| Si | 16956 | 2977 | 82% |
| Al | 4407 | 771 | 83% |
| Mg | 8976 | 4425 | 51% |

### Example 3

The experimental setup was the same as in Example 1. The mixture of raw phosphate-containing material in water and cadmium removing agent was kept under stirring condition for about 1 hour, at ambient pressure and a temperature of about 100° C. Decantation, filtration, and first and second washing processes as defined in Example 1 were also conducted. The washed treated phosphate-containing material was sent to Neutron Activation Analysis to identify the elements present in the material and determine the concentration of each of the elements. The results obtained are outlined in Table 3 below.

TABLE 3
Concentration of elements in the phosphate-containing material before
and after treatment (1 hour, temperature of about 100° C., and
ambient pressure). Data obtained from Neutron Activation Analysis.

| | Raw | Treated | | | Raw | Treated | |
|---|---|---|---|---|---|---|---|
| | phosphate- | phosphate- | | | phosphate- | phosphate- | |
| | containing | containing | | | containing | containing | |
| | material | material | Removal | | material | material | Removal |
| Element | (mg/kg) | (mg/kg) | efficiency | Element | (mg/kg) | (mg/kg) | efficiency |
| Ca | 357621 | 42129 | 88% | Br | 2.8 | 1.9 | 32% |
| Si | 13000 | 2600 | 80% | Rb | 6 | 1.7 | 72% |
| Na | 5269 | 101 | 98% | Zr | 71 | 35 | 51% |
| Al | 2547 | 119 | 95% | Mo | 1.6 | 1.0 | 33% |
| Mg | 1954 | 75 | 96% | Ag | 64 | 0.8 | 99% |
| Fe | 1405 | 73 | 95% | Cd | 10.7 | 1.3 | 88% |
| K | 602 | 34 | 94% | In | 0.04 | 0.006 | 86% |
| Zn | 268 | 52 | 81% | Sn | 49 | 4.5 | 91% |
| Cr | 252 | 10 | 96% | Sb | 2.4 | 0.11 | 95% |
| Ti | 198 | 28 | 86% | I | 78 | 2.34 | 97% |
| Cl | 145 | 6 | 96% | Cs | 0.3 | 0.18 | 33% |
| V | 138 | 6 | 96% | Ba | 113 | 11.4 | 90% |
| U | 118 | 0.0029 | 100% | La | 92 | 3.09 | 97% |
| Co | 1.2 | 0.6 | 50% | Hf | 0.7 | 0.13 | 83% |
| Ni | 69 | 11 | 84% | W | 0.3 | 0.035 | 89% |
| Cu | 10 | 2.4 | 77% | Hg | 8.3 | 0.08 | 99% |
| As | 7.0 | 0.3 | 96% | Th | 2.1 | 0.11 | 95% |
| Se | 3.6 | 1.1 | 70% | Sc | 7.9 | 0.84 | 89% |
| Mn | 14 | 1.08 | 92% | | | | |

The process according to the invention allows for the removal of metals and other impurities in a phosphorus-containing material. The process comprises causing the material to react with a metal removing agent which comprises an organophosphorus compound. As will be understood by a skilled person, the phosphorus in the phosphorus-containing material may be in a form which is: phosphate (PO₄³⁻), phosphoric acid (H₃PO₄), phosphate pentoxide (P₂O₅) or a derivative thereof or a combination thereof. In embodiments of the invention, the phosphorus-containing material is a phosphate-containing material. Such material may comprise phosphate rocks, a sediment or the like.

The metal content of the material used in embodiments of the invention have been measured using a technique known in the art as Neuron Activation Analysis. The analysis has yielded the following metals: Cd, U, Ca, V, Ti, Sn, Sr, Ag, Mn, Si, Al, Mg, Na, Fe, K, Zn, Cr, Cl, V, Co, Ni, Cu, As, Se, Br, Rb, Zr, Mo, In, Sn, Sb, I, Cs, Ba, La, Hf, W, Hg, Th and Sc. As will be understood by a skilled person, an analysis using another technique may yield other metals. Such other technique includes for example as atomic absorption spectrometry (AAS), atomic emission/fluorescent spectrometry (AES/AFS), inductively-coupled plasma mass spectroscopy (ICP-MS), inductively-coupled plasma optical emission spectrometry (IC-OES), X-ray fluorescence (XRF) and anodic striping voltammetry (AVS). Accordingly, the material according to the invention may comprise other metals not included in the above list.

The organophosphorus compound comprised in the metal removing agent used in the process according to the invention may have a general formula which is I or II outlined below, wherein R₁ to R₃ are each independently a C₁ to C₂₀ a linear or branched, cyclic or non-cyclic, saturated or unsaturated alkyl group, optionally comprising a heteroatom which is O, S or N. in embodiments of the invention, each one of R₁ to R₃ is a C₂ to C₁₀ or a C₂ to C₈ a linear or branched, cyclic or non-cyclic, saturated or unsaturated alkyl group, optionally comprising a heteroatom which is O, S or N.

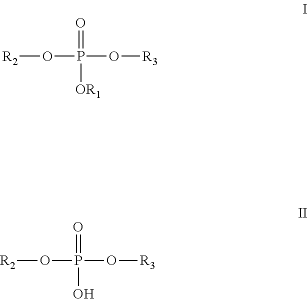

In embodiments of the invention the metal removing agent comprises di-(2-ethylhexyl)phosphoric acid outlined below

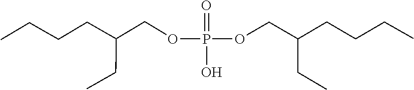 [SMILES: CCCCC(CC)COP(=O)(O)OCC(CC)CCCC]

Also in embodiments of the invention, the metal removing agent may be selected from the group consisting of: di-(2-ethylhexyl) phosphoric acid, bis(2-ethylhexyl) phosphate, bis(2-ethylhexyl) hydrophosphoric acid, bis(2-ethylhexyl) hydrogen phosphate, bis(2-ethylhexyl) orthophosphate, di-(2-ethylhexyl) orthophosphoric acid, dioctyl hydrogen phosphate, dioctyl orthophosphate, dioctyl phosphate, 2-ethyl-1-hexanol hydrogen phosphate, 1-hexanol-2-ethyl hydrogen phosphate, hydrogen bis(2-ethylhexyl) phosphate, 0,0-bis(2-ethylhexyl)phosphoric acid, orthophosphoric acid 2-ethylhexyl alcohol, phosphoric acid di(2-ethylhexyl) ester and Hostarex PA 216™.

The temperature of the treatment reaction between the phosphorus-containing material and the metal removing agent may vary. In embodiments of the invention the temperature may be the ambient temperature or between about 15 to 50° C., about 20 to 40° C., about 20 to 35° C., about 20 to 30° C., about 25° C., about 40 to 120° C., about 50 to 100° C., about 60 to 100° C., about 70 to 100° C., about 80 to 100° C., about 100° C.

Also, the pressure during the treatment reaction between the phosphorus-containing material and the metal removing agent may vary. In embodiments of the invention, the pressure may be the ambient pressure, or a pressure of about 100 bars, or at a pressure higher than 100 bars.

As will be understood by a skilled person, the process of the invention involves various technical step such as decantation and filtration. The process also involves washing steps. For example, after the reaction treatment between the phosphorus-containing material and the metal removing agent, the mixture is subjected the mixture to a washing step using a mixture of water and an organic solvent. The reacted metal removing agent passes into the washing fluid. The phosphorus-containing material and the fluid are thereafter separated by decantation and filtration.

In embodiments of the invention, a slurry of the phosphorus-containing material into water is prepared prior to conducting the treatment reaction. In these embodiments, the reaction mixture is submitted to decantation and filtration prior to a first washing step. It should be noted that the process may comprise more than one washing step.

An amount of metal removing agent used in the process of the invention depends on the amount of starting/raw phosphorus material. Such amount varies and may be for example between about 0.1 to 100 vol % or about 10 to 100 vol % or about 20 to 100 vol % or about 30 to 100 vol % or about 40 to 100 vol % or about 50 to 100 vol % or about 60 to 100 vol % or 70 to 100 vol % or about 80 to 100 vol % or about 90 to 100 vol % or about 100 vol %. In embodiments of the invention wherein a water slurry of the phosphorus-containing material is prepared prior to the treatment reaction, such amount may be for example between is about 0.1 to 15 vol % or about 0.1 to 10 vol % or about 0.1 to 5 vol % or about 0.1 to 3 vol % or about 0.1 vol % or about 1 vol %.

The washing fluid used in the various washing steps of the process according to the invention may be the same or different. In embodiments of the invention, the washing fluid comprises an organic solvent which may be an alcohol such as a C₁ to C₆ alcohol including but not limited to ethanol. An amount of the organic solvent in the washing fluid may be between about 0.1 to 15 vol % or about 0.5 to 10 vol % or about 1 to 8 vol % or about 1 to 5 vol % or about 1 vol %.

The treatment reaction between the phosphorus-containing material and the metal removing agent may be conducted in a liquid, gas or plasma phase.

In embodiments of the invention where it is desired to conduct the reaction treatment between the phosphorus-containing material and the metal removing agent at a temperature higher than ambient temperature, the higher temperature is provided using microwave, ultrasound, induction heating, plasma or a combination thereof.

Stirring during the reaction treatment between the phosphorus-containing material and the metal removing agent is provided using a mechanical stirrer or a gas flow comprising air, nitrogen or a combination thereof.

In embodiments of the invention, any metal removing agent and water used in the process may be recovered, regenerated and re-used in the process.

The process according to the invention may be conducted as a continuous flow, a batch, a semi-batch or a combination thereof.

The invention thus provides for a treated phosphorus-containing material which has a metal and other impurities content lower than a metal and other impurities content in the starting phosphorus-containing material, for example about 1 to 100% lower. In embodiments of the invention, the treated phosphorus-containing material has a cadmium content which may be between about 10 to 20% or about to 30 to 40% or about 40 to 50% or about 50 to 60% or about 60 to 70% or about 70 to 80% or about 80 to 90% or about 90 to 100% or about 32% or about 54% or about 88% lower than a cadmium content in the starting phosphorus-containing material. The treated phosphorus-containing material may be substantially free of cadmium.

The invention provides for a system adapted to carry out the process of the invention. Such system may be integrated in a transportation and/or storage system for the transportation and/or storage of a phosphorus-containing material. Such transportation and/or storage system may be for example a pipeline, a tank, a container or a combination thereof.

The scope of the claims should not be limited by the preferred embodiments set forth in the examples; but should be given the broadest interpretation consistent with the description as a whole.

The present description refers to a number of documents, the content of which is herein incorporated by reference in their entirety.

1. A process for removing metals and other impurities in a phosphorus-containing material, comprising causing the material to react with a metal removing agent which comprises an organophosphorus compound.

2. The process according to claim 1, wherein the phosphorus in the phosphorus-containing material is in a form which is: phosphate (PO₄³⁻), phosphoric acid (H₃PO₄), phosphate pentoxide (P₂O₅) or a derivative thereof or a combination thereof.

3. The process according to claim 1, wherein the material is a phosphate-containing material.

4. The process according to claim any one of claims 1 to 3, wherein the material is phosphate rocks or a sediment or a combination thereof.

5. The process according to claim any one of claims 1 to 4, wherein the metals and other impurities, as measured by Neuron Activation Analysis, comprise at least one of: Cd, U, Ca, V, Ti, Sn, Sr, Ag, Mn, Si, Al, Mg, Na, Fe, K, Zn, Cr, Cl, V, Co, Ni, Cu, As, Se, Br, Rb, Zr, Mo, In, Sn, Sb, I, Cs, Ba, La, Hf, W, Hg, Th and Sc.

6. The process according to claim any one of claims 1 to 4, wherein the metals and other impurities comprise cadmium (Cd).

7. The process according to any one of claims 1 to 6, wherein the metal removing agent comprises a phosphate ester of general formula I outlined below 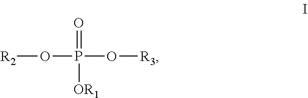
wherein R₁ to R₃ are each independently a C₁ to C₂₀ a linear or branched, cyclic or non-cyclic, saturated or unsaturated alkyl group, optionally comprising a heteroatom which is O, S or N.

8. The process according to any one of claims 1 to 6, wherein the metal removing agent comprises a phosphoric acid ester of general formula II outlined below 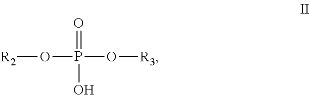
wherein R₂ and R₃ are each independently C₁ to C₂₀ a linear or branched, cyclic or non-cyclic, saturated or unsaturated alkyl group, optionally comprising a heteroatom which is O, S or N.

9. The process according to claim 7 or 8, wherein R₁ to R₃ are each independently a C₂ to C₁₀ or a C₂ to C₈ a linear or branched, cyclic or non-cyclic, saturated or unsaturated alkyl group, optionally comprising a heteroatom which is O, S or N.

10. The process according to any one of claims 1 to 6, wherein the metal removing agent comprises di-(2-ethylhexyl)phosphoric acid (DEHPA or HDEHP) outlined below

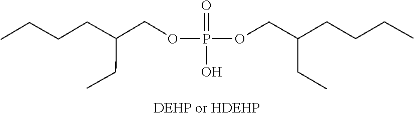 [SMILES: CCCCC(CC)COP(=O)(O)OCC(CC)CCCC]

11. The process according to any one of claims 1 to 6, wherein the metal removing agent is selected from the group consisting of: di-(2-ethylhexyl) phosphoric acid, bis(2-ethylhexyl) phosphate, bis(2-ethylhexyl) hydrophosphoric acid, bis(2-ethylhexyl) hydrogen phosphate, bis(2-ethylhexyl) orthophosphate, di-(2-ethylhexyl) orthophosphoric acid, dioctyl hydrogen phosphate, dioctyl orthophosphate, dioctyl phosphate, 2-ethyl-1-hexanol hydrogen phosphate, 1-hexanol-2-ethyl hydrogen phosphate, hydrogen bis(2-ethylhexyl) phosphate, O,O-bis(2-ethylhexyl)phosphoric acid, orthophosphoric acid 2-ethylhexyl alcohol, phosphoric acid di(2-ethylhexyl) ester and Hostarex PA 216™.

12. The process according to any one of claims 1 to 11, wherein the metal removing agent is a cadmium removing agent.

13. The process according to any one of claims 1 to 12, wherein the temperature is: about 15 to 50° C., about 20 to 40° C., about 20 to 35° C., about 20 to 30° C., about 25° C., about 40 to 120° C., about 50 to 100° C., about 60 to 100° C., about 70 to 100° C., about 80 to 100° C., about 100° C.

14. The process according to any one of claims 1 to 12, wherein the temperature is the ambient temperature.

15. The process according to any one of claims 1 to 12, wherein the temperature is about 100° C.

16. The process according to any one of claims 1 to 15, which is conducted at ambient pressure, or at a pressure of about 100 bars, or at a pressure higher than 100 bars.

17. The process according to any one of claims 1 to 15, which is conducted at ambient pressure.

18. The process according to any one of claims 1 to 17, further comprising at least one of: a decantation and filtration step, and a washing step, optionally the decantation and filtration step and/or the washing step is repeated one time or more.

19. A process for removing metals and other impurities in a phosphorus-containing material, comprising:
(i) providing the phosphorus-containing material;
(ii) adding a metal removing agent which comprises an organophosphorus compound, and stirring the mixture for a period of time, to yield a mixture comprising a treated phosphorus-containing material and a reacted metal removing agent;
(iii) adding a washing fluid comprising water and an organic solvent, and stirring the mixture for a period of time; and
(iv) separating the treated phosphorus-containing material which is in solid form and the washing fluid comprising the reacted metal removing agent;
optionally steps (iii) and (iv) are repeated one time or more, the washing fluid being the same or different.

20. A process for removing metals and other impurities in a phosphorus-containing material, comprising:
(a) providing the phosphorus-containing material;
(b) preparing a slurry of the phosphorus-containing material in water and maintaining the slurry under stirring;
(c) adding a metal removing agent which comprises an organophosphorus compound to the slurry under stirring, and stirring the mixture for a period of time;
(d) stopping the stirring and allowing the mixture to stand for a period of time, thereby causing formation of a precipitate comprising a treated phosphorus-containing material and a layer of water comprising a reacted metal removing agent;
(e) separating the precipitate comprising the treated phosphorus-containing material from the layer of water;
(f) washing the precipitate comprising the treated phosphorus-containing material using a washing fluid comprising water and an organic solvent; and
(g) separating the treated phosphorus-containing material from the washing fluid,
optionally steps (f) and (g) are repeated one time or more, the washing fluid being the same or different.

21. The process according to claim 19 or 20, wherein step (ii) or step (c) is conducted at a temperature of about 15 to 50° C., about 20 to 40° C., about 20 to 35° C., about 20 to 30° C., about 25° C., about 40 to 120° C., about 50 to 100° C., about 60 to 100° C., about 70 to 100° C., about 80 to 100° C., about 100° C.

22. The process according to claim 19 or 20, wherein step (ii) or step (c) is conducted at ambient temperature.

23. The process according to claim 19 or 20, wherein step (ii) or step (c) is conducted at a temperature of about 100° C.

24. The process according to claim 19 or 20, wherein step (ii) or step (c) is conducted at ambient pressure, or at a pressure of about 100 bars, or at a pressure higher than 100 bars.

25. The process according to claim 19 or 20, wherein step (ii) or step (c) is conducted at ambient pressure.

26. The process according to any one of claim 19 or 25, wherein step (ii) or step (c) is conducted in a phase which is liquid, gas, plasma or a combination thereof.

27. The process according to claim 20, wherein step (f) comprises adding the washing fluid to the precipitate and stirring the mixture for a period of time.

28. The process according to claim 20, further comprising submitting the layer of water of step (e) to a treatment to recover and regenerate the metal removing agent and water, separately; optionally each of the metal removing agent and water recovered is re-used in the process.

29. The process according to any one of claims 19 to 28, further comprising submitting the washing fluid of step (iv) or step (g) to a treatment to recover and regenerate the metal removing agent and water, separately; optionally each of the metal removing agent and water recovered is re-used in the process.

30. The process according to any one of claims 19 to 29, wherein an amount of the metal removing agent is about 0.1 to 100 vol % or about 10 to 100 vol % or about 20 to 100 vol % or about 30 to 100 vol % or about 40 to 100 vol % or about 50 to 100 vol % or about 60 to 100 vol % or 70 to 100 vol % or about 80 to 100 vol % or about 90 to 100 vol % or about 100 vol % based on an amount of the phosphorus-containing material.

31. The process according to any one of claims 19 to 29, wherein an amount of the metal removing agent is about 0.1 to 15 vol % or about 0.1 to 10 vol % or about 0.1 to 5 vol % or about 0.1 to 3 vol % or about 0.1 vol % or about 1 vol % based on an amount of the phosphorus-containing material.

32. The process according to any one of claims 19 to 31, wherein the organic solvent is an alcohol, optionally a C₁ to C₆ alcohol including ethanol.

33. The process according to any one of claims 19 to 32, wherein an amount of the organic solvent in the washing fluid is about 0.1 to 15 vol % or about 0.5 to 10 vol % or about 1 to 8 vol % or about 1 to 5 vol % or about 1 vol %.

34. The process according to claim 21, wherein a temperature higher than ambient temperature is provided using microwave, ultrasound, induction heating, plasma or a combination thereof.

35. The process according to any one of claims 19 to 34, wherein stirring is provided using a mechanical stirrer or a gas flow comprising air, nitrogen or a combination thereof.

36. The process according to any one of claims 1 to 35, which is conducted as a continuous flow, a batch, a semi-batch or a combination thereof.

37. The process according to any one of claims 19 to 36, wherein the phosphorus-containing material is a phosphate-containing material.

38. A phosphorus-containing material treated according to the process as defined in any one of claims 1 to 37.

39. The phosphorus-containing material according to claim 38, which has a metal and other impurities content lower than a metal and other impurities content in the starting phosphorus-containing material.

40. The phosphorus-containing material according to claim 38, which has a cadmium content lower than a cadmium content in the starting phosphorus-containing material.

41. The phosphorus-containing material according to claim 38, which has a cadmium content about to 1 to 100% lower than a cadmium content in the starting phosphorus-containing material.

42. The phosphorus-containing material according to claim 38, which has a cadmium content about 10 to 20% or about to 30 to 40% or about 40 to 50% or about 50 to 60% or about 60 to 70% or about 70 to 80% or about 80 to 90% or about 90 to 100% or about 32% or about 54% or about 88% lower than a cadmium content in the starting phosphorus-containing material.

43. The phosphorus-containing material according to claim 38, which is substantially free of cadmium.

44. A system adapted to conduct the process as defined in any one of claims 1 to 37.

45. A transportation and/or storage system for the transportation and/or storage of a phosphorus-containing material, comprising a system adapted to conduct the process as defined in any one of claims 1 to 37; optionally the transportation and/or storage system is a pipeline, a tank, a container or a combination thereof.
